(19) United States
(12) Patent Application Publication
(10) Pub. No.: US 2024/0006650 A1
(43) Pub. Date: Jan. 4, 2024

(54) ALL-SOLID-STATE BATTERY AND METHOD OF MANUFACTURING THE SAME

(71) Applicants: Hyundai Motor Company, Seoul (KR); Kia Corporation, Seoul (KR)

(72) Inventor: Dae Won Lee, Suwon (KR)

(73) Assignees: Hyundai Motor Company, Seoul (KR); Kia Corporation, Seoul (KR)

(21) Appl. No.: 18/065,402

(22) Filed: Dec. 13, 2022

(30) Foreign Application Priority Data
Jul. 1, 2022 (KR) 10-2022-0081021

(51) Int. Cl. H01M 10/04; H01M 50/548; H01M 50/595

(52) U.S. Cl. CPC H01M 10/0436; H01M 50/548; H01M 50/595

(57) ABSTRACT

Disclosed are an all-solid-state battery and a method of manufacturing the same. A unit cell of the all-solid-state battery includes a positive electrode, and single-sided negative electrodes configured to be stacked on a first surface and a second surface of the positive electrode, wherein, among the single-sided negative electrodes, a first single-sided negative electrode includes no negative electrode terminal, and a second single-sided negative electrode includes a negative electrode terminal.

### CROSS-REFERENCE TO RELATED APPLICATION

This application claims under 35 U.S.C. § 119(a) the benefit of Korean Patent Application No. 10-2022-0081021 filed on Jul. 1, 2022, the entire contents of which are incorporated herein by reference.

### BACKGROUND

### Technical Field

The present disclosure relates to an all-solid-state battery and a method of manufacturing the same.

### Background

A secondary battery is an energy storage device which is rechargeable. In most secondary batteries, cells are manufactured based on a liquid electrolyte which is an organic solvent and are thus limited in terms of improvement in stability and energy density. Therefore, all-solid-state batteries using a solid electrolyte are being vigorously developed now.

As an all-solid-state battery uses a solid electrolyte instead of a liquid electrolyte, it requires formation of interfaces having high quality between the electrodes, i.e., a positive electrode and a negative electrode, and the electrolyte, so as to secure performance, such as energy density. For this purpose, a high-pressure pressing process configured to firmly press electrode materials and an electrolyte structure against each other is employed. The interfaces between the electrodes, i.e., the positive electrode and the negative electrode, and the electrolyte are secured through the high-pressure pressing process, and a cell stack is manufactured by stacking a plurality of unit cells having secured interfaces. However, when the cell stack is formed by stacking the plurality of unit cells, it is difficult to form interfaces between the respective cells. In order to solve such a problem, the interfaces between the unit cells are removed using single-sided negative electrodes.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to solve the above-described problems associated with the existing technologies, and it is an object of the present disclosure to provide an all-solid-state battery which facilitates formation of interfaces and has improved quality.

It is another object of the present disclosure to provide a method of manufacturing an all-solid-state battery in which the all-solid-state battery is manufactured through a simplified process.

In one embodiment, the present disclosure provides a unit cell of an all-solid-state battery, including a cathode, and two single-sided negative electrodes configured to be stacked on a first surface and a second surface of the cathode, respectively, wherein, among the single-sided negative electrodes, a first single-sided negative electrode includes no negative electrode terminal, and a second single-sided negative electrode includes a negative electrode terminal.

In some embodiments, an insulating tape may be disposed between the first single-sided negative electrode and the second single-sided negative electrode to surround a circumference of the positive electrode.

In some embodiments, the insulating tape may be adhered to an edge of at least one of the single-sided negative electrodes.

In some embodiments, the negative electrode terminal extends outwardly from the second single-sided negative electrode.

In some embodiments, each of the single-sided negative electrodes is configured such that a negative electrode active material is applied to one surface thereof.

In one embodiment, a cell stack including the unit cell is provided.

In one embodiment, a method of manufacturing an all-solid-state battery including the unit cell of including: 1) feeding a continuous negative electrode sheet; 2) adhering a continuous sheet of insulating tape to the negative electrode sheet; and 3) cutting the negative electrode sheet having the continuous sheet of insulating tape adhered thereto along cut lines formed in advance on the continuous sheet of insulating tape.

In some embodiments, the negative electrode sheet may be a first negative electrode sheet for the first single-sided negative electrode, and the first negative electrode sheet may include no negative electrode terminal.

In some embodiments, the continuous sheet of insulating tape may include subsidiary parts configured to extend farther outwardly than the negative electrode sheet.

In some embodiments, cutting the negative electrode sheet may include: 1) slitting the subsidiary parts along the cut lines; and 2) cutting the negative electrode sheet along the cut lines after slitting the subsidiary parts.

In some embodiments, slitting the subsidiary parts may include winding the slit subsidiary parts into a form of a roll.

In some embodiments, the negative electrode sheet and the insulating tape continuum may be continuously fed.

In some embodiments, the negative electrode sheet may be a second negative electrode sheet for the second single-sided negative electrode, and the seconds negative electrode sheet may include the negative electrode terminal.

In some embodiments, the negative electrode terminal may be processed on the second negative electrode sheet simultaneously with cutting the second negative electrode sheet or at a different time from cutting the second negative electrode sheet.

In one embodiment, a method of manufacturing an all-solid-state battery is provided, the method including 1) stacking a first single-sided negative electrode on a first surface of a positive electrode; and 2) stacking a second single-sided negative electrode on a second surface of the positive electrode. The first single-sided negative electrode may include no negative electrode terminal, and the second single-sided negative electrode may include a negative electrode terminal.

In some embodiments, the method may further include pressing a first unit cell formed by stacking the first single-sided negative electrode, the positive electrode and the second single-sided negative electrode.

In some embodiments, an insulating tape may be adhered to the first single-sided negative electrode to surround a circumference of the positive electrode.

In some embodiments, the method may further include stacking a second unit cell having a same structure as the first unit cell on the first unit cell; and pressing a cell stack formed by stacking the first unit cell and the second unit cell.

In certain embodiments, negative electrode is suitably rigid, and in other embodiments the negative electrode may be flexible.

As discussed, the method and system suitably include use of a controller or processer.

Other embodiments and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a perspective view of a unit cell of an all-solid-state battery;

FIG. 2 is a perspective view of a cell stack formed by stacking a plurality of unit cells;

FIG. 3A is an exploded perspective view of FIG. 1;

FIG. 3B is a longitudinal-sectional view taken along line VI-VI′ of FIG. 1;

FIG. 4A is a longitudinal-sectional view of a unit cell including a double-sided negative electrode;

FIG. 4B is a longitudinal sectional view of a cell stack formed by stacking a plurality of unit cells shown in FIG. 4A;

FIG. 5 is a longitudinal-sectional view of FIG. 2;

FIG. 6 is a longitudinal-sectional view of a cell stack of an all-solid-state battery according to one embodiment of the present disclosure;

FIG. 7 is an exploded perspective view of the cell stack of the all-solid-state battery according to one embodiment of the present disclosure;

FIG. 8 is a plan view showing respective layers of the cell stack of the all-solid-state battery according to one embodiment of the present disclosure, arranged in order;

FIG. 9 is a top view illustrating a process of manufacturing a general unit cell;

FIG. 10 is a top view illustrating a process of manufacturing a unit cell according to one embodiment of the present disclosure; and

FIG. 11 is a side view schematically illustrating the process of manufacturing the unit cell according to one embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Specific structural or functional descriptions in embodiments of the present disclosure set forth in the description which follows will be exemplarily given to describe the embodiments of the present disclosure, and the present disclosure may be embodied in many alternative forms. Further, it will be understood that the present disclosure should not be construed as being limited to the embodiments set forth herein, and the embodiments of the present disclosure are provided only to completely disclose the disclosure and cover modifications, equivalents or alternatives which come within the scope and technical range of the disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

In the following description of the embodiments, terms, such as “first” and “second”, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the drawings to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, steps, operations, elements, components, and/or combinations thereof, but do not preclude the presence or addition of one or more other features, integers, steps, operations, elements, components, and/or combinations thereof.

Hereinafter the embodiments of the present disclosure will be described in detail with reference to the accompanying drawings.

As described above, single-sided negative electrodes are employed to secure interfaces between unit cells in a cell stack. However, use of the single-sided negative electrodes may require use of a larger amount of a base material than an amount needed in the cell stack and may cause increase in the number of negative electrode terminals and degradation of welding performance. Further, in case in which an insulating tape is adhered to an all-solid-state battery, use of the single-sided negative electrodes may complicate manufacture of the all-solid-state battery, and this will be described in detail below.

Therefore, the present disclosure is to solve the above-described problems by omitting the terminal of any one of single-sided negative electrodes which are bonded to each other.

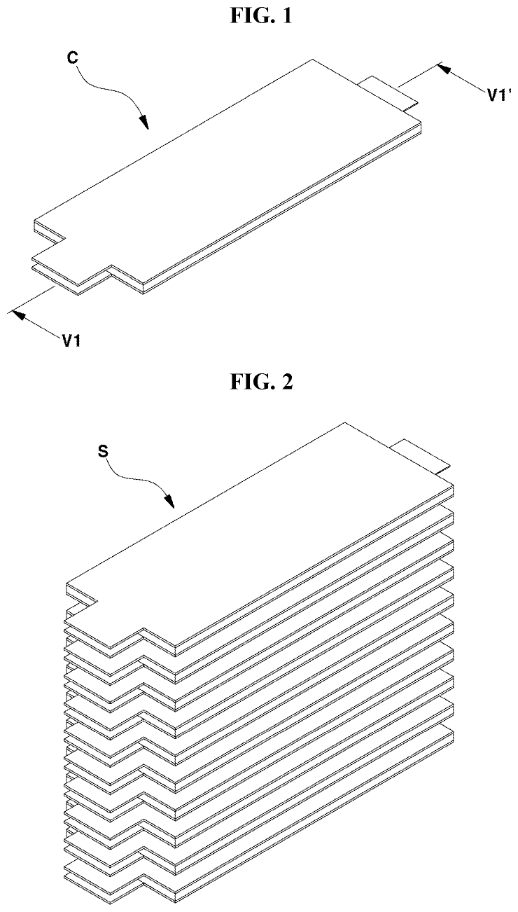

As shown in FIGS. 1 and 2, a cell stack S of an all-solid-state battery may be formed by stacking a plurality of unit cells C. For example, several to several tens of unit cells C may be stacked to form the cell stack S.

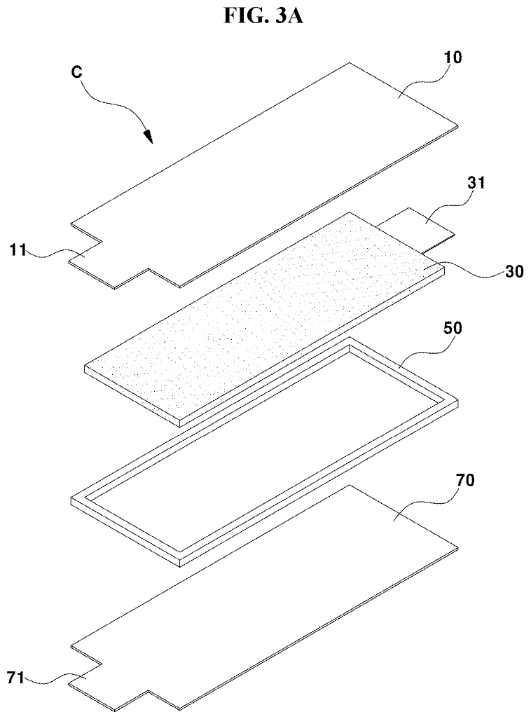

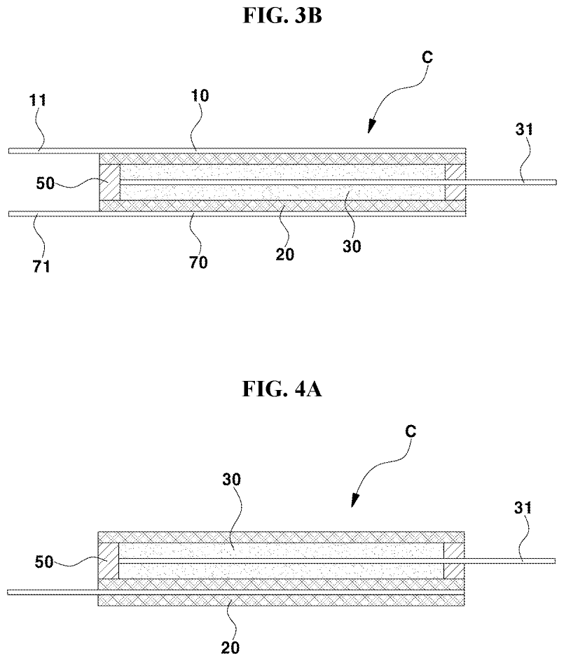

Referring to FIG. 3A, the unit cell C may include an upper negative electrode 10, a positive electrode 30, an insulating tape 50 and a lower negative electrode 70. Here, the upper negative electrode 10 and the lower negative electrode 70 are single-sided negative electrodes. A negative electrode generally includes a negative electrode current collector and a negative electrode active material, and a single-sided negative electrode refers to a negative electrode in which the negative electrode active material is applied to only one side of the current collector. As described above, in order to form interfaces between the unit cells C stacked in the cell stack S, single-sided negative electrodes rather than double-sided negative electrodes are employed as the negative electrodes 10, 70.

Each of the respective negative electrodes 10, 70 and the positive electrode 30 may include a terminal. That is, the upper negative electrode 10 includes an upper negative electrode terminal 11, a lower negative electrode 70 includes a lower negative electrode terminal 71, and the positive electrode 30 includes a positive electrode terminal 31. The respective terminals 11, 71 and 31 extend or protrude outwardly from the corresponding electrodes 10, 70 and 30.

In the description of the present disclosure, one of the negative electrodes 10, 70 of the unit cell C is referred to as the upper negative electrode 10, and the other is referred to as the lower negative electrode 70. These terms are used only to distinguish both negative electrodes 10, 70 from each other in consideration of the state of the unit cell C shown in the drawings, and are not used to specify the positions of the negative electrodes 10, 70.

As shown in FIG. 3B, in order to manufacture the unit cell C, first, the insulating tape 50 may be adhered to one surface of one negative electrode, for example, the lower negative electrode 70. Since the size of the positive electrode 30 is generally smaller than the size of the negative electrodes 10, 70, the insulating tape 50 may be provided to compensate for a dimension difference between the positive electrode 30 and the negative electrodes 10, 70. For example, the insulating tape 50 may be a ring-shaped insulating material and may be adhered to the edge of the lower negative electrode 70. After the insulating tape 50 has been adhered to the lower negative electrode 70, the positive electrode 70 is mounted on the lower negative electrode 70 to be located inside the insulating tape 50 Thereafter, the upper negative electrode 10 is adhered to the positive electrode 70 to cover the free surface of the positive electrode 70. The above-manufactured unit cell C secures interfaces between the negative electrodes 10, 70 and the positive electrode 30 through a pressing process.

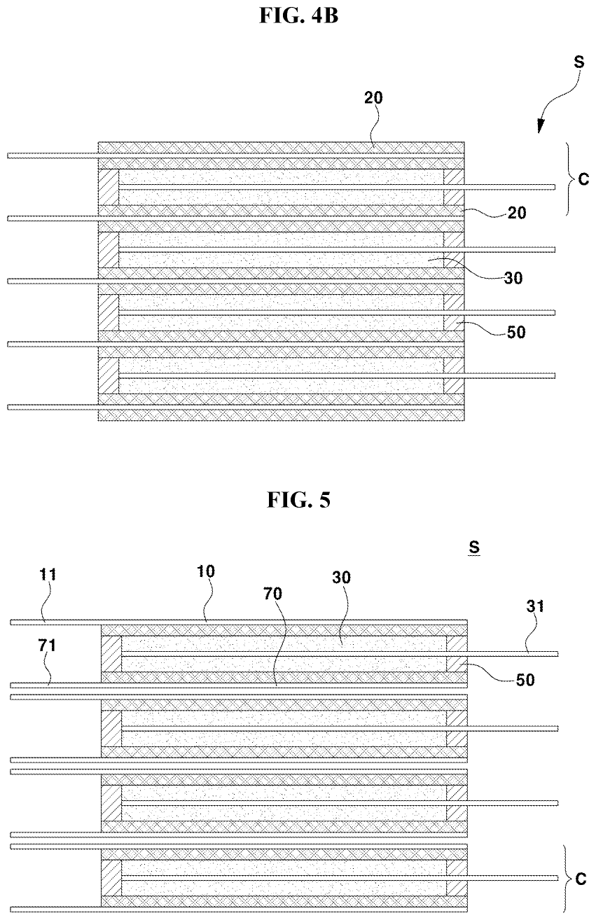

FIG. 4A shows a unit cell C including a double-sided negative electrode 20. The unit cell C including the double-sided negative electrode 20 has no difficulty in securing interfaces in the unit cell C. However, when a cell stack S is manufactured by stacking a plurality of unit cells C, a high-pressure pressing process is not employed between the unit cells C, and thus, it is difficult to secure interfaces between the unit cells C in the cell stack S.

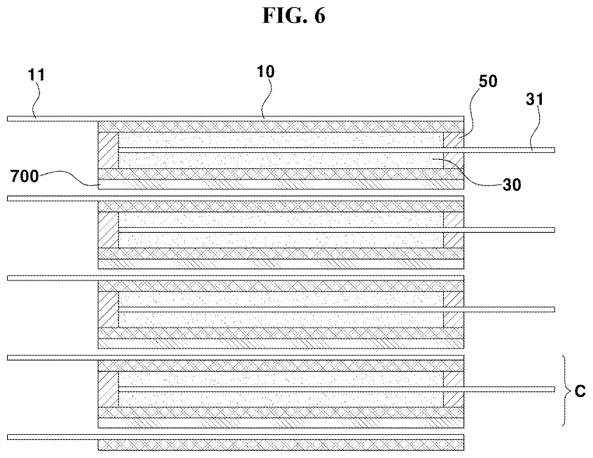

Therefore, the unit cells C having the single-sided negative electrodes 10, 70 may be used. Referring to FIG. 5, in the cell stack S including the unit cells C including the single-sided negative electrodes 10, 70, interfaces between the unit cells C may be omitted, and electrons may be moved between the negative electrodes 10, 70 bonded to each other, for example, between the lower negative electrode 70 of a first cell C and the upper negative electrode 10 of a second cell C adjacent to the first cell C in the cell stack S. Through comparison between FIGS. 4B and 5, it may be confirmed that the cell stack S having the single-sided negative electrodes may have a larger number of negative electrode terminals than the cell stack S having the double-sided negative electrodes. In this case, welding performance may be degraded.

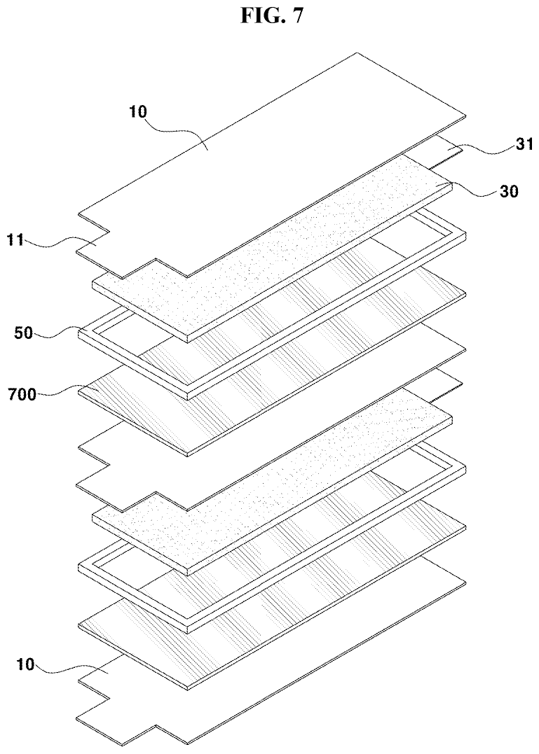

Referring to FIGS. 6 to 8, according to the present disclosure, the unit cell C may include two negative electrodes formed in different shapes. Concretely, any one of an upper negative electrode 10 and a lower negative electrode 700 is configured to have no terminal. For example, the lower negative electrode 700 may be configured to have a different shape from the upper negative electrode 10 to have no terminal. Hereinafter, the lower negative electrode 700 will be described as having no terminal, but the present disclosure is not limited thereto and the upper negative electrode 100 may be configured to have no terminal.

Referring to FIG. 9, the negative electrode 10 or 70 may be manufactured from a negative electrode sheet 40 which is continuously formed. That is, the upper negative electrode 10 or the lower negative electrode 70 may be manufactured from the negative electrode sheet 40 which is continuously formed. The negative electrode 10 or 70 having the insulating tape 50 adhered thereto is manufactured by adhering the insulating tape 50 to the negative electrode sheet 40 and cutting the negative electrode sheet 40 to a predetermined size along a cut line L1. During this process, the terminal 11 or 71 configured to transport electrons therethrough is formed on the negative electrode 10 or 70 using a terminal processing machine 60 (i.e., a notching process).

Adhesion of the insulating tape 50 to the negative electrode sheet 40, aligning the formation positions of the terminals 11 or 71 with cut positions of the negative electrode sheet into the respective negative electrodes 10, 70 and size matching cause a high level of difficulty in an automation process and require high investment costs. The insulating tape 50 serves to prevent damage to the all-solid-state battery due to a dimension difference between the negative electrodes and the positive electrodes in the high-pressure pressing process. However, aligning the formation positions of the negative electrode terminals with the adhesion positions of the insulating tape to the negative electrode sheet 40 during the above-described negative electrode processing process is difficult. Further, when the terminals are formed during this process, it is difficult to manage a mold and to discharge scraps due to the adhesive of the insulating tape.

The present disclosure may reduce the number of negative electrode terminals in a cell stack, may improve welding performance in the cell stack, and may simplify a negative electrode manufacturing process. According to the present disclosure, the insulating tape 50 is adhered to the lower negative electrode 700 having no terminal. According to the present disclosure, the insulating tape 50 is adhered to the lower negative electrode 700 having no terminal, thereby being capable of improving productivity and contributing to cost reduction.

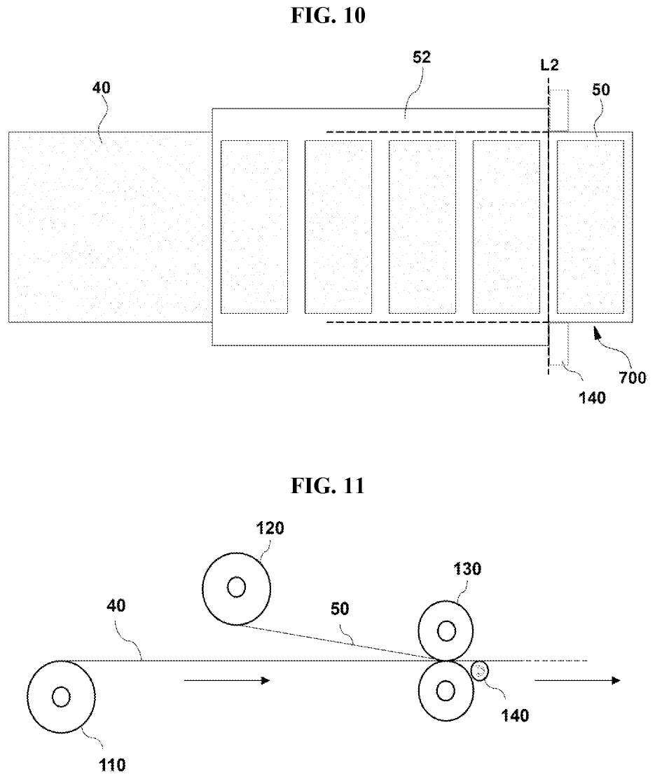

Manufacture of the lower negative electrode 700 having no terminal will be described below. As shown in FIGS. 10 and 11, first, the insulating tape 50 is adhered to the negative electrode sheet 40. The negative electrode sheet 40 and the insulating tape 50 may be provided in the form of a roll. The negative electrode sheet 40 may be configured to be unwound from a negative electrode roller 110 The insulating tape 50 may be configured to be unwound from an insulating tape roller 120. The insulating tape 50 may be adhered to the negative electrode sheet 40 by a processing unit 130, and subsidiary parts 52 of the insulating tape 50 may be slit along cut lines L2. Additionally, the negative electrode sheet 40 is cut into respective negative electrodes 700 along the cut lines L2.

According to the present disclosure, the notching process, which forms terminals of negative electrodes, may not be required, and thus, the insulating tape 50 may include the subsidiary parts 52. Further, when the negative electrode 10 or 70 includes the negative electrode terminal 11 or 71, as shown in FIG. 9, the width of the insulating tape 50 is restrictive and thus the insulating tape 50 may not include the subsidiary parts 52. The insulating tape having such a shape causes difficulties in continuously generating scraps and securing rigidity during movement of the insulating tape 50. According to the present disclosure, the insulating tape 50 including the subsidiary parts 52 may secure rigidity against deformation which may occur when the insulating tape 50 is moved from the insulating tape roller 120 before being adhered to the negative electrode sheet 40. The subsidiary parts 52 are slitted and the negative electrode sheet 40 are cut along the cut lines L2, thereby providing the negative electrode 700 having no terminal and configured such that the insulting tape 50 is adhered to the negative electrode 700. Further, the subsidiary parts 52 may be discharged as continuous scraps, and may be wound on a recovery roller 140.

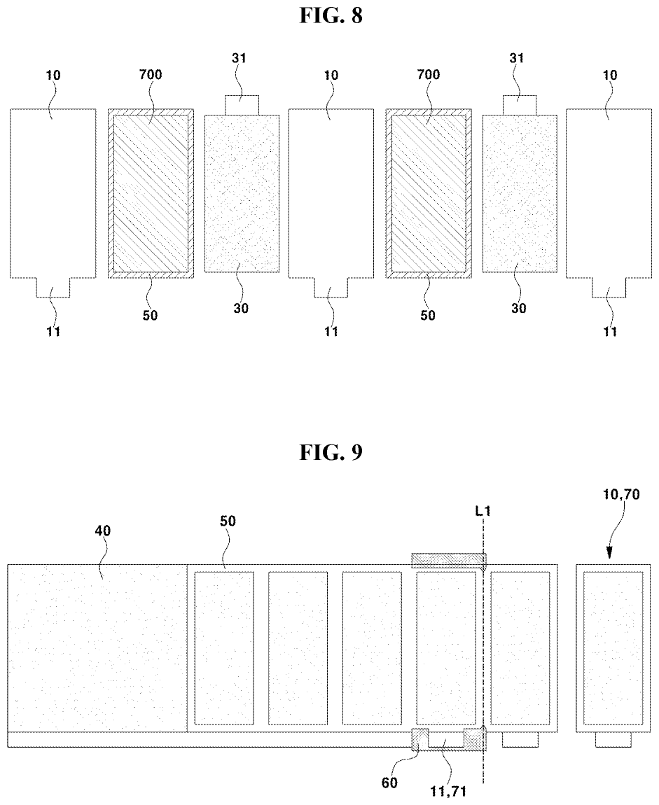

According to some embodiments of the present disclosure, a unit cell C may be manufactured by stacking the upper negative electrode 10, the positive electrode 30, and the lower negative electrode 700. Referring again to FIG. 8, the upper negative electrode 10 is stacked on one surface of the positive electrode 30, and the lower negative electrode 700 is stacked on the other surface of the positive electrode 30. Further, the insulating tape 50 is adhered to one surface of the lower negative electrode 700 to be disposed around the circumference of the positive electrode 30. The unit cell C securing interfaces between the electrodes may be manufactured by pressing the upper negative electrode 10, the positive electrode 30 and the lower negative electrode 700 which are stacked, using a high-pressure press.

Further, as shown in FIG. 6, a cell stack S may be formed by sequentially stacking a plurality of the respective unit cells C. After formation of the cell stack S, additional pressing using the high-pressure press may be performed.

As described above, the upper negative electrode 10 may be manufactured from the negative electrode sheet 40 including negative electrode terminals 11. In order to acquire an individual upper negative electrode 10, the negative electrode terminal 11 is formed through the terminal processing machine 60, and the negative electrode sheet 40 is cut into the individual upper negative electrode 10. Formation of the negative electrode terminal 11 and cutting of the negative electrode sheet 40 into the individual upper negative electrode 10 may be performed simultaneously or may be performed at different times at regular intervals.

The lower negative electrodes 700 may be manufactured from the negative electrode sheet 40 including no negative electrode terminals. Thus, the negative electrode sheet 40 may be directly cut into an individual negative electrode 700 without requiring a process of forming a negative electrode terminal.

As described above, the present disclosure may provide an all-solid-state battery which may reduce the number of negative electrode terminals so as to reduce welding energy between the terminals and to have improved quality.

Further, the all-solid-state battery according to the present disclosure may not require a notching process of forming terminals, thereby being capable of preventing damage to a mold due to fixation of the adhesive of an insulating tape. Moreover, the all-solid-state battery according to the present disclosure may remove clogging due to generation of discontinuous scraps. In addition, the all-solid-state battery according to the present disclosure may recover scraps through winding of continuous scraps.

The all-solid-state battery according to the present disclosure may omit terminals and may thus facilitate position control and improve accuracy through aligning the cut positions of the insulting tape with the cut positions of a negative electrode sheet into respective negative electrodes without requiring matching the cut positions of the insulting tape and the formation positions of the terminals.

As is apparent from the above description, the present disclosure may provide an all-solid-state battery which facilitates formation of interfaces, and has improved quality.

Further, the present disclosure may provide a method of manufacturing an all-solid-state battery in which the all-solid-state battery is manufactured through a simplified process.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A unit cell of an all-solid-state battery, comprising:
a positive electrode; and
two single-sided negative electrodes configured to be stacked on a first surface and a second surface of the positive electrode, respectively,
wherein, among the single-sided negative electrodes, a first single-sided negative electrode comprises no negative electrode terminal, and a second single-sided negative electrode comprises a negative electrode terminal.

2. The unit cell of claim 1, further comprising an insulating tape disposed between the first single-sided negative electrode and the second single-sided negative electrode to surround a circumference of the positive electrode.

3. The unit cell of claim 2, wherein the insulating tape is adhered to an edge of at least one of the single-sided negative electrodes.

4. The unit cell of claim 1, wherein the negative electrode terminal extends outwardly from the second single-sided negative electrode.

5. The unit cell of claim 1, wherein each of the single-sided negative electrodes is configured such that a negative electrode active material is applied to one surface thereof.

6. A cell stack comprising the unit cell of claim 1.

7. A method of manufacturing an all-solid-state battery including the unit cell of claim 1, comprising:
feeding a continuous negative electrode sheet;
adhering a continuous sheet of insulating tape to the negative electrode sheet; and
cutting the negative electrode sheet having the continuous sheet of insulating tape adhered thereto along cut lines formed in advance on the continuous sheet of insulating tape.

8. The method of claim 7, wherein the negative electrode sheet is a first negative electrode sheet for the first single-sided negative electrode, and the first negative electrode sheet comprises no negative electrode terminal.

9. The method of claim 8, wherein the continuous sheet of insulating tape comprises subsidiary parts configured to extend farther outwardly than the negative electrode sheet.

10. The method of claim 9, wherein cutting the negative electrode sheet comprises:
slitting the subsidiary parts along the cut lines; and
cutting the negative electrode sheet along the cut lines after slitting the subsidiary parts.

11. The method of claim 10, wherein slitting the subsidiary parts comprises:
winding the slit subsidiary parts into a form of a roll.

12. The method of claim 7, wherein the negative electrode sheet and the insulating tape continuum are continuously fed.

13. The method of claim 7, wherein the negative electrode sheet is a second negative electrode sheet for the second single-sided negative electrode, and the seconds negative electrode sheet comprises the negative electrode terminal.

14. The method of claim 13, wherein the negative electrode terminal is processed on the second negative electrode sheet simultaneously with cutting the second negative electrode sheet or at a different time from cutting the second negative electrode sheet.

15. A method of manufacturing an all-solid-state battery, comprising:
stacking a first single-sided negative electrode on a first surface of a positive electrode; and
stacking a second single-sided negative electrode on a second surface of the positive electrode,
wherein the first single-sided negative electrode comprises no negative electrode terminal, and the second single-sided negative electrode comprises a negative electrode terminal.

16. The method of claim 15, further comprising:
pressing a first unit cell formed by stacking the first single-sided negative electrode, the positive electrode and the second single-sided negative electrode.

17. The method of claim 15, wherein an insulating tape is adhered to the first single-sided negative electrode to surround a circumference of the positive electrode.

18. The method of claim 15, further comprising:
stacking a second unit cell having a same structure as the first unit cell on the first unit cell; and
pressing a cell stack formed by stacking the first unit cell and the second unit cell.
